(19) United States
(12) Patent Application Publication
(10) Pub. No.: US 2019/0034318 A1
(43) Pub. Date: Jan. 31, 2019

(54) Hardware-Software Co-Verification for Debugging Firmware on a Hardware Simulator

(71) Applicant: Western Digital Technologies, Inc., San Jose, CA (US)

(72) Inventor: Igal Mariasin, Be'er Sheva (IL)

(21) Appl. No.: 15/659,645

(22) Filed: Jul. 26, 2017

(51) Int. Cl. G06F 11/36

(52) U.S. Cl. CPC G06F 11/3664; G06F 11/3688; G06F 11/3648

(57) ABSTRACT

A co-verification manager is used to enable a software debugger application to debug firmware on a hardware simulator. The co-verification manager receives a non-native command from the software debugger application, parses the command, and maps the command into a command/task native to the specific simulated hardware configuration. The hardware simulator executes the native task on the hardware configuration instantiated by the hardware simulator. Data resulting from the execution of the native task is then sent from the hardware simulator to the co-verification manager, and returned the debugger.

### TECHNICAL FIELD

The present disclosure relates generally to firmware development, and more specifically to software level debugging of firmware on a hardware simulator.

### BACKGROUND

Several different environments exist for developing and debugging firmware, each of which has limitations. Hardware simulator environments are one option. An example of this environment is a software based test bench for simulating a hardware description language (“HDL”) model. Debugging firmware in a hardware simulator environment is typically limited to using print statements in the code and analyzing log reports after code execution. These debugging techniques are less than ideal because they require frequent editing and rerunning of the code.

Software based hardware modelers are another firmware development environment (for example, SystemC hardware models). The main challenge here is that there is always a difference between the software based approximation and the actual hardware. Firmware developed using hardware models typically experiences execution problems when it is run on the subsequently developed actual hardware, because the actual hardware and the hardware models do not exactly match.

Hardware-based emulation platforms, such as Cadence® Palladium, are another possible firmware development environment. Hardware emulation is the process of imitating the behavior of one or more pieces of hardware (typically a system under design) with another piece of hardware. However, these hardware-based emulation systems are highly priced and cost significant dollar amounts per user license.

It would be desirable to resolve these issues.

### SUMMARY

The present disclosure relates to using a co-verification manager to enable a software debugger application to debug firmware on a hardware simulator. In one embodiment, a system comprises a processor and memory, the memory having programmed modules such as a receiving module, a parsing module, a mapping module and a transmitting module. The receiving module receives a command from a software debugger application, the received command being non-native to a specific hardware configuration being simulated on a hardware simulator. The parsing module parses the received non-native command. The mapping module maps the received non-native command to a command native to the specific simulated hardware configuration. The transmitting module provides the mapped native command to the hardware simulator for execution on the specific simulated hardware configuration. The receiving module receives data resulting from the execution of the mapped native command by the hardware simulator on the specific simulated hardware configuration. The transmitting module transmits the received data to the software debugger application.

In another embodiment, a method may comprise receiving, by a co-verification manager executing on a computer, a command from a software debugger application, the received command being non-native to a specific hardware configuration being simulated on a hardware simulator; parsing, by the co-verification manager, the received non-native command; mapping, by the co-verification manager, the received non-native command to a command native to the specific simulated hardware configuration; providing, by the co-verification manager, the mapped native command to the hardware simulator for execution on the specific simulated hardware configuration; receiving, by the co-verification manager, data resulting from the execution of the mapped native command by the hardware simulator on the specific simulated hardware configuration; and transmitting, from the co-verification manager to the software debugger application, the received data.

Other implementations of one or more of these aspects include corresponding systems, apparatus, and computer program products configured to perform the actions of the methods.

These and other implementations may optionally include one or more of the following features, such as, but not limited to: a co-verification manager that instantiates the receiving module, the parsing module, the mapping module, and the transmitting module, the co-verification manager comprising a script providing network communication server functionality establishing a communication protocol session between the hardware simulator and the software debugger application; a set of interface functions that map non-native commands received from the software debugger application to native commands executable by the hardware simulator on the specific simulated hardware configuration; the mapped native commands further comprising commands that utilize names of internal signals and chip timing native to the specific simulated hardware configuration; the mapped native commands further comprising commands that read from and commands that write to registers of the specific simulated hardware configuration; the co-verification manager further enabling utilization of the software debugger application to debug code native to the specific simulated hardware configuration; the utilization of the software debugger application to debug code on the specific simulated hardware configuration further comprising setting a software breakpoint in the software debugger application that stops execution of the native code on the specific simulated hardware configuration; the specific simulated hardware configuration further comprising a hardware description language instantiation comprising register-transfer level configuration parameters describing the specific simulated hardware configuration and predefined tasks native to the specific simulated hardware configuration; the predefined tasks native to the specific simulated hardware configuration comprising functional chip initialization, direct memory interface and functional bus interface tasks; modifying the simulated hardware configuration based on data resulting from executing the predefined tasks native to the specific simulated hardware configuration, wherein modifying the simulated hardware configuration further comprises modifying a register-transfer level configuration parameter in the hardware description language; data resulting from the execution of the task by the hardware simulator comprising functional and timing verification data concerning the specific simulated hardware configuration; and the software debugger application and the hardware simulator being executed on separate computers.

Moreover, it should be understood that the language used in the present disclosure has been principally selected for readability and instructional purposes, and is not intended to limit the scope of the subject matter disclosed herein.

### BRIEF DESCRIPTION OF THE DRAWINGS

FIG. 1 is a block diagram of an exemplary network architecture in which a co-verification manager can be implemented, according to some embodiments.

FIG. 2 shows an example computing device on which a co-verification manager resides, according to some embodiments.

FIG. 3 is a flowchart illustrating a method for operation of a co-verification manager, according to some embodiments.

FIG. 4 is a flowchart showing the operation of the co-verification manager over time, according to some embodiments.

FIGS. 5 and 6 show example methods for utilizing a software debugger application, according to some embodiments, to debug non-native code intended for a specific simulated hardware configuration.

FIG. 7 illustrates an example method for modifying a specific simulated hardware configuration, according to some embodiments.

The Figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The technology disclosed herein includes various aspects, such as systems, methods, apparatuses, computer-readable media, computer program products, etc., for software level debugging of firmware on a hardware simulator. By way of example, the innovative technology disclosed herein can test and debug hardware code/firmware using a debug environment that is non-native to the platform upon which the hardware is instantiated and/or simulated. As used herein, the word “native” refers to an item or code that is implemented specifically for a given application or hardware configuration.

Non-native debug environments may comprise software debuggers with advanced debug features such as Microsoft Visual Studio IDE. Such non-native software debuggers provide beneficial features such as automatic spell checking and word completion (IntelliSence) for firmware developers not conventionally available in hardware simulator environments. As disclosed herein, the co-verification manager enables these non-native debuggers can provide feedback about syntax and compilation errors during the coding of the firmware in the hardware simulator environment. In some embodiments of the present disclosure, using such debuggers allows firmware to be modified and run during a current simulation without the need to wait for a hardware simulation session to be completed and/or restarted. In some embodiments, these debuggers allow for setting breakpoints that stop/pause the execution when specified instructions/conditions are reached. Values in memory and registers can also be examined and manipulated during execution in the hardware simulator environment.

Furthermore, the technology disclosed herein allows for testing of firmware on simulated hardware that mimics the actual intended hardware. This allows for development and debugging of the firmware before the actual physical implementation of the hardware components in question. Starting firmware development during the hardware development phase can reduce the time of the development cycle significantly.

Further, the systems and methods disclosed herein can provide the flexibility to remotely develop and debug firmware. This is accomplished by having a developer operate from a computing device having a non-native software debugger application at one location with a hardware simulator at another location. This location independent benefit results from having a co-verification manager server as an intermediary between the software debugger application and the hardware simulator.

It should be understood that the above list of features and advantages is not all-inclusive and many additional features and advantages are contemplated and fall within the scope of the present disclosure.

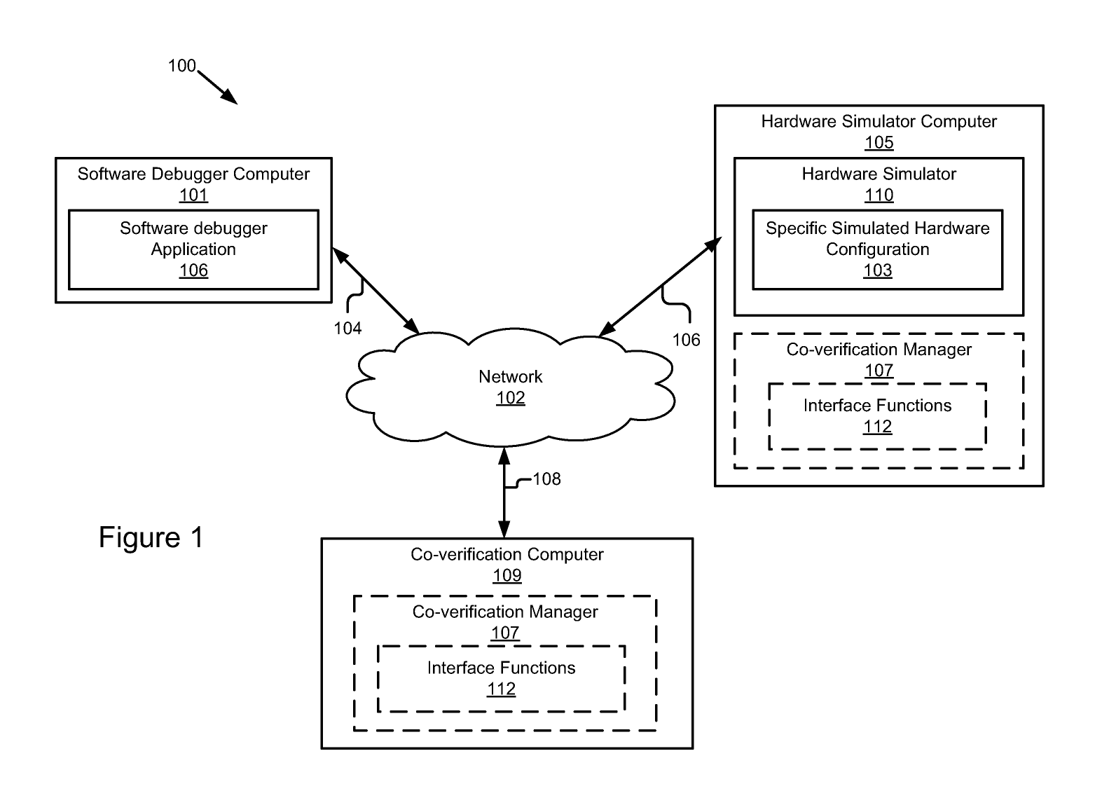

FIG. 1 is a block diagram of an exemplary network architecture 100 in which a co-verification manager 107 can be implemented, according to some embodiments. The illustrated network architecture 100 comprises a software debugger computer 101, hardware simulator computer 105, and a co-verification manager computer 109. It is to be understood that in various embodiments, various functionalities of this system 100 can be instantiated on a single computer or can be distributed between multiple computers.

The network 102 shown in FIG. 1 connects via signal lines 104, 106 and 108 the software debugger computer 101, the hardware simulator computer 105 and server 109 respectively. The network 102 can be a conventional or unconventional type, wired or wireless, and may have numerous different configurations. Furthermore, the network 102 may comprise a wide area network (WAN) (e.g., the Internet), a local area network (LAN), and/or other interconnected data paths across which multiple devices may communicate. In some embodiments, the network 102 may be a peer-to-peer network. The network 102 may also be coupled to or include portions of a telecommunications network for sending data in a variety of different communication protocols. In some embodiments, the network 102 may include Bluetooth communication networks or a cellular communications network for sending and receiving data including via short messaging service (SMS), multimedia messaging service (MMS), hypertext transfer protocol (HTTP), direct data connection, WAP, email, etc. Although FIG. 1 illustrates one network 102 communicatively coupling the software debugger computer 101, hardware simulator 105 computer and co-verification computer 109, in practice one or more networks 102 can be connected to these entities.

The software debugger computer 101 can be in the form of any computing device capable of running a software debugger application 106 such as Microsoft Visual Studio Debugger. In other embodiments, other software debugger applications 106 are used, such as Eclipse, Advanced Debugger (adb), GNU Debugger (GDB), etc.

The hardware simulator computer 105 can be in the form of any computing device on which a hardware simulator 110 can run. The hardware simulator 110 can instantiate a specific simulated hardware configuration written in a hardware description language (HDL). In some embodiments, the specific simulated hardware configuration comprises register transfer level (RTL) designs that are generated using an open source and/or proprietary hardware description language (HDL). Example open source and proprietary HDLs are Verilog-AMS and Altera Hardware description languages, respectively. In sum embodiments, hardware simulators on which HDLs can be implemented include ModelSim by Mentor Graphics, Incisive Enterprise Simulator by Cadence and VCS by Synopsys.

The co-verification manager 107 depicted in FIG. 1 enables utilization of the software debugger application 106 to debug code (i.e., firmware) native to the specific simulated hardware configuration 103. In some embodiments, the co-verification manager may be implemented in the form of a script that can provide network communication server functionality establishing a protocol session between the hardware simulator 110 and the software debugger application 106. In one embodiment, this script can be written using Tool Command Language (TCL). It is noted that the co-verification manager 107 can either reside on the co-verification computer 109, the hardware simulator computer 105 and/or one or more other computing devises as desired. The functionalities of the co-verification manager 107 can be distributed between multiple computing devices, including within a cloud-based computing environment in which the functionality of the co-verification manager 107 is provided as a service over a network 102. The co-verification manager 107 is described in more detail below.

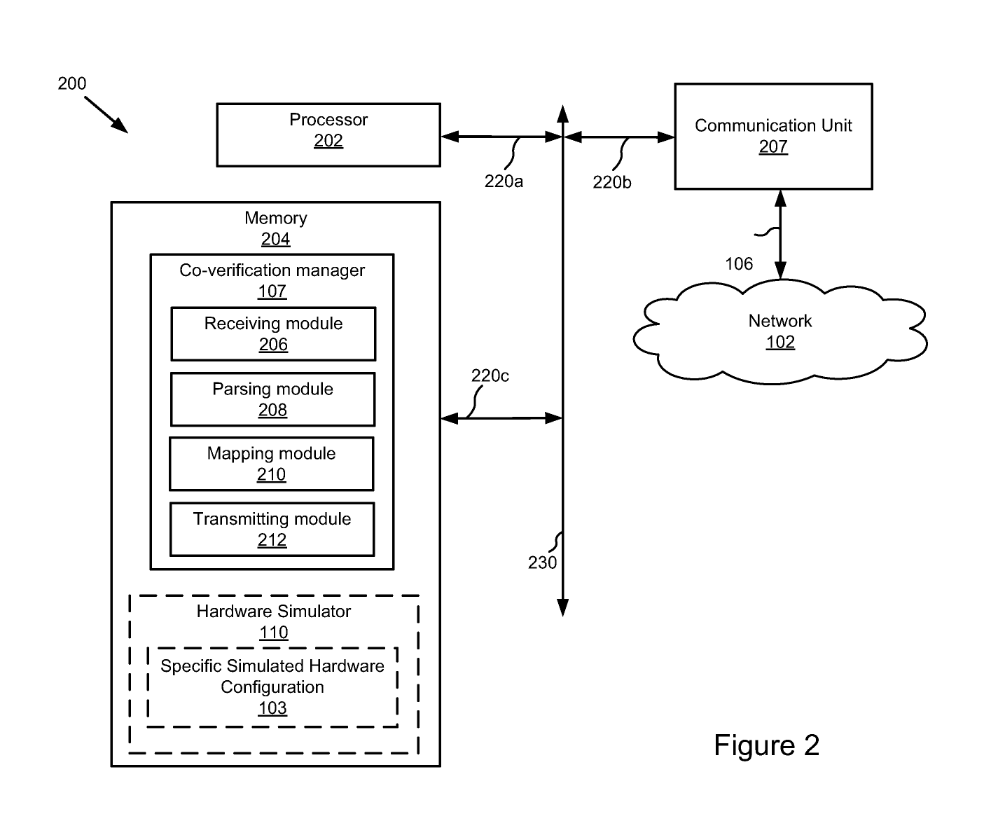

FIG. 2 shows an example computing device 200 on which a co-verification manager 107 resides, according to some embodiments. In one embodiment, the co-verification manager can instantiate a receiving module 206, a parsing module 208, a mapping module 210, and a transmitting module 212, configured for receiving and mapping non-native commands received from the software debugger application 106 to native commands executable by the hardware simulator 110 on the specific simulated hardware configuration 103. It is to be understood that although the key exchange transposition system 101 is illustrated in FIG. 2 as standalone entity, the illustrated co-verification manager 107 represents a collection of functionalities, which can be instantiated as a single or multiple modules on one or more computing devices as desired. FIG. 2 illustrates a specific embodiment in which the co-verification manager 107 is instantiated in the form of specific, multiple modules instantiated on a single computing device 200. It is to be understood that the hardware simulator computer 105 and the software debugger computer 101 can also be in the form of computing devices 200 such as the one illustrated in FIG. 2.

The processor 202 is coupled via signal line 220a to the bus 230 for communication with the other components of the computing device 200. Processor 202 processes data signals and may include various computing architectures including a complex instruction set computer (CISC) architecture, a reduced instruction set computer (RISC) architecture, or an architecture implementing a combination of instruction sets. Although only a single block is shown for the processor 202 in the example of FIG. 2, multiple processors and/or processing cores may comprise the processor 202.

Additionally, while a particular processor 202 configuration is depicted in FIG. 2, it should be understood that other processor 202 configurations are also encompassed by this disclosure. In some embodiments, the processor 202 may include any processor having one or more arithmetic logic units, microprocessors, general-purpose controllers, or some other processor arrays to perform computations and provide electronic display signals to a display device. For instance, the processor 202 can comprise a hardware processor having one or more processing cores.

The memory 204 may include one or more non-transitory computer-usable (e.g., readable, writeable, etc.) media, which can include any non-transitory apparatus or device that can contain, store, communicate, propagate or transport instructions, data, computer programs, software, code, routines, etc., for processing by or in connection with the processor 202. For example, non-transitory memory may include, but is not limited to, dynamic random access memory (DRAM) device, static random access memory (SRAM) device, or another volatile or non-volatile memory device.

The memory 204 may store instructions and/or data that may be executed by a processor (e.g., the processor 202). The memory 204 is coupled for communication with the other components of the computing system 200 via signal line 220c. The instructions and/or data stored in the memory 204 may comprise code in the form of the script associated with the co-verification manager, the script comprising the modules (206-212) configured to map non-native commands to specific simulated hardware configurations 103. In some cases, the instructions may include other instructions for manipulating data (not depicted in FIG. 2). In alternate embodiments, the memory 204 may also store code representing the hardware simulator 110 with a specific simulated hardware configuration 103 or portions thereof.

The bus 230 may include a communication bus for transferring data between components of a computing device (e.g., hardware simulator computer 105, software debugger computer 101 and a co-verification computer 109) or between two or more computing devices, a network bus system, a processor mesh, SATA, SCSI, SAS, PCI, PCIe, and/or or any other suitable type of internal and/or external communication bus for transferring data between components of a computing and/or storage device and/or between components of disparate components. In some embodiments, the computing devices (e.g., hardware simulator computer 105, software debugger computer 101 and co-verification computer 109, etc.) may cooperate and communicate via a software communication mechanism implemented in association with the bus 230. The software communication mechanism may include and/or facilitate, for example, inter-process communication, local function or procedure calls, remote procedure calls, network-based communication, secure communication, etc.

The communication unit 207 may include one or more interface devices for wired and wireless connectivity with a computer network to which the computing device 200 (e.g. hardware simulator computer 105, software debugger computer 101 and co-verification computer 109, etc.) may be coupled, such as other computing devices 200, data sources, etc. For instance, the communication unit 207 may include, but is not limited to, CAT-type interfaces; wireless transceivers for sending and receiving signals using Wi-Fi™; Bluetooth®, cellular communications, etc.; bus interfaces; USB interfaces; proprietary connection types; various combinations thereof; etc. In some embodiments, the communication unit 207 can link the processor 202 to a network, which may in turn be coupled to other processing systems. The communication unit 207 can provide other connections to the network 102 and to other entities of the system 100 using various standard communication protocols, including, for example, those discussed elsewhere, herein.

The hardware simulator computer 105, the software debugger computer 101 and the co-verification computer 109 may comprise other components in various embodiments, such as one or more of a graphics processor; a physical keyboard; a Bluetooth® module; memory storing applicable firmware; and/or various physical connection interfaces (e.g., HDMI, headset jack, etc.); etc. Additionally, an operating system for managing the hardware and resources of the computing device 200, application programming interfaces (APIs) for providing applications access to the hardware and resources, a user interface module (not shown) for generating and displaying interfaces for user interaction and input, and applications including, for example, applications for manipulating documents, images, e-mail(s), and applications for web browsing, etc., may be stored and operable on the computing device 201.

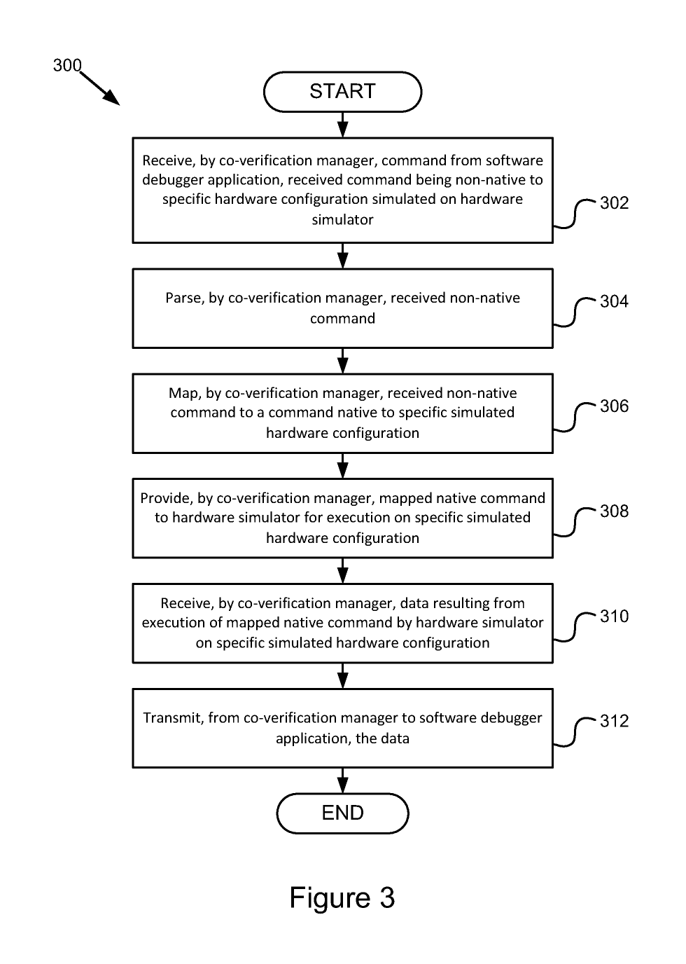

FIG. 3 is a flowchart 300 illustrating operation of the co-verification manager 107, according to some embodiments. In the course of firmware development on the hardware simulator 110, a developer can utilize the software debugger application 106 to debug the firmware, through the use of the co-verification manager 107.

This enables the benefit of the advantages of the software level debugger, which are not conventionally available when debugging firmware on a hardware simulator. As noted above, the software debugger application can provide features such as automatic spell check and word completion, feedback about syntax, flagging of compilation errors, modification and recompilation of firmware during an active hardware simulation session without the need to restart, setting of breakpoints, analysis of memory and register contents during execution, etc.

Turning to the flowchart 300, at block 302 the receiving module of the co-verification manager receives a command from the software debugger application, the received command being non-native to a specific simulated hardware configuration being simulated on a hardware simulator 105. In some embodiments, the received non-native commands are commands from the software debugger application, which are written in a format/language that is non-native to the specific simulated hardware configuration, as described in detail; below. The received commands are parsed and mapped to commands that are native to the specific simulated hardware configuration as explained below.

At block 304 of FIG. 3, the parsing module of the co-verification manager parses the received non-native command. The parsing module is configured to read the received command and break the received command into analyzable parts that can be mapped to one or more native command(s). In some embodiments, the received command comprises a case-insensitive keyword comprising printable ASCII characters, which may be followed by one or more arguments.

For example, a command from the software debugger application which reads a register location from the specific simulated hardware configuration can be unsigned int READ_MEM(HW_REG*addr). Analyzable parts of this command may be the data type that must be returned responsive to the executing the command (i.e., unsigned int data type), the command itself (i.e., READ_MEM( ) command), and the location of the simulated hardware configuration to be read (i.e., HW_REG*addr location).

As noted elsewhere herein, the received command is in a format foreign or non-native to the hardware simulator or the firmware. For instance, received commands originating from a software debugger application such as Microsoft Visual Studio will not be understandable or meaningful to a hardware simulator such as ModelSim. This is because ModelSim is not configured to support or execute commands from Microsoft Visual Studio. As such, the co-verification manager provides a layer (whether external or internal to the hardware simulator) that can facilitate a translation/interpretation of commands from one platform to another.

More specifically, in some embodiments the parsing module, in conjunction with the mapping module provides this extra layer that can understand, among other things, the functionality associated with each received non-native command. Thus, the parsing module is configured to interpret the received non-native command from the software debugger application and the mapping module is programmed to map the non-native command to one or more commands native to the specific simulated hardware configuration.

Continuing at block 306 of FIG. 3, the mapping module of the co-verification manager maps the received non-native command to a command native to the specific simulated hardware configuration. In some embodiments, the mapped native command described may correspond to a predefined task native to the specific simulated hardware configuration. For example, the predefined tasks may comprise functional chip initialization, direct memory interface and functional bus interface tasks native to the specific simulated hardware configuration. In other embodiments, these mapped native commands can comprise commands that utilize names of internal signals and chip timing native to the specific simulated hardware configuration. In some embodiments, the mapped native commands may comprise commands that read from and commands that write to registers of the specific hardware configuration. In other embodiments, the mapped native commands can comprise commands that read from and commands that write to memory of the specific simulated hardware configuration. Other non-limiting examples mapped native commands comprise commands that can drive register transfer level (RTL) designs generated as the specific simulated hardware configuration. Other examples of mapped native commands are native commands that advance the hardware simulation for a specified period of time (e.g., 1000 nanoseconds), or until occurrence of a specific hardware event (e.g., a given interrupt). Mapped native commands to connect and disconnect to the hardware simulator are other examples.

At block 308, the transmitting module of the co-verification manager provides the mapped native command to the hardware simulator for execution on the specific simulated hardware configuration. Thus, the system and method presented herein can enable a software debugger application to send non-native commands to be executed on a hardware simulator that does not natively understand, among other things, commands from the software debugger application absent the parsing and mapping modules.

Responsive to the hardware simulator executing the mapped native command on the specific simulated hardware configuration, the hardware simulator may present data comprising return values, etc., regarding the execution of the native commands to the receiving module. The receiving module receives this data from the hardware simulator at block 310. In some embodiments, this data, resulting from the execution of the native command by the hardware simulator, may comprise functional and timing verification data concerning the specific simulated hardware configuration after the execution of the mapped native command on the simulated hardware configuration.

At block 312 of FIG. 3, the transmitting module can transmit to the software debugger application, the received data. In some embodiments, receiving this data from the firmware executing on the enables the software debugger application to operate on the specific simulated hardware configuration executing on the hardware simulator. Note that the software debugger application itself is unaware of the specific simulated hardware configuration executing on the hardware simulator, and conventionally could not interact therewith.

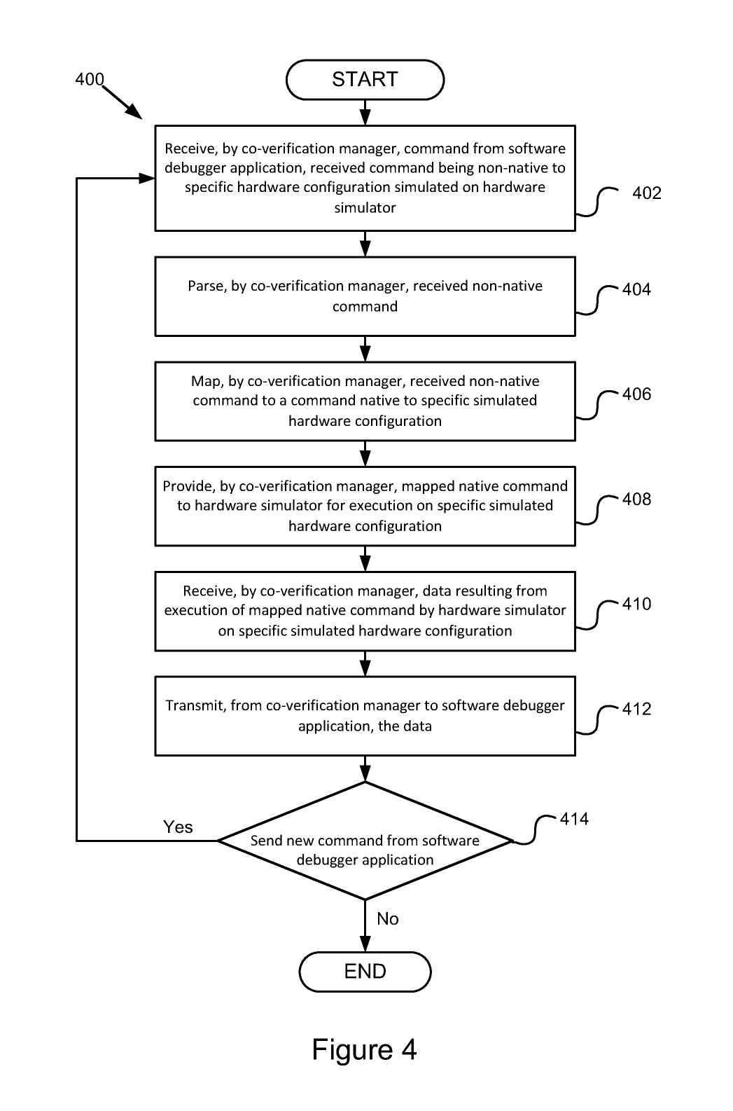

FIG. 4 is a flowchart 400 showing the operation of the co-verification manager over time, according to some embodiments. While blocks 402, 404, 406, 408, 410 and 412 shown in this figure are respectively analogous to steps 302, 304, 306, 308, 310 and 312 of FIG. 3, FIG. 4 has an additional conditional block 414 which illustrates the reception of new commands from the software debugger application. For instance, the software debugger application can send multiple new commands from the software debugger application, responsive to the transmitting module transmitting data from the co-verification manager to the software debugger application. More particularly, when a new command is received at block 414 of FIG. 4, the co-verification flowchart 400 resumes at block 402 and continues down to block 412. When the software debugger application sends an exit command or the like, the method 400 terminates.

In one embodiment, the method 400 provides a repeat cycle of receiving non-native software debugger commands, parsing and mapping these non-native commands to commands native to a specific simulated hardware configuration, sending the native commands to the hardware simulator on which the specific simulated hardware configuration is instantiated, executing the native command by the hardware simulator on the specific simulated hardware configuration, receiving return values from the execution of the native commands and providing the return values to the software debugger application. This repeat cycle can occur as a user/developer operating the software debugger application uses the software debugger application to debug code executing on the hardware simulator.

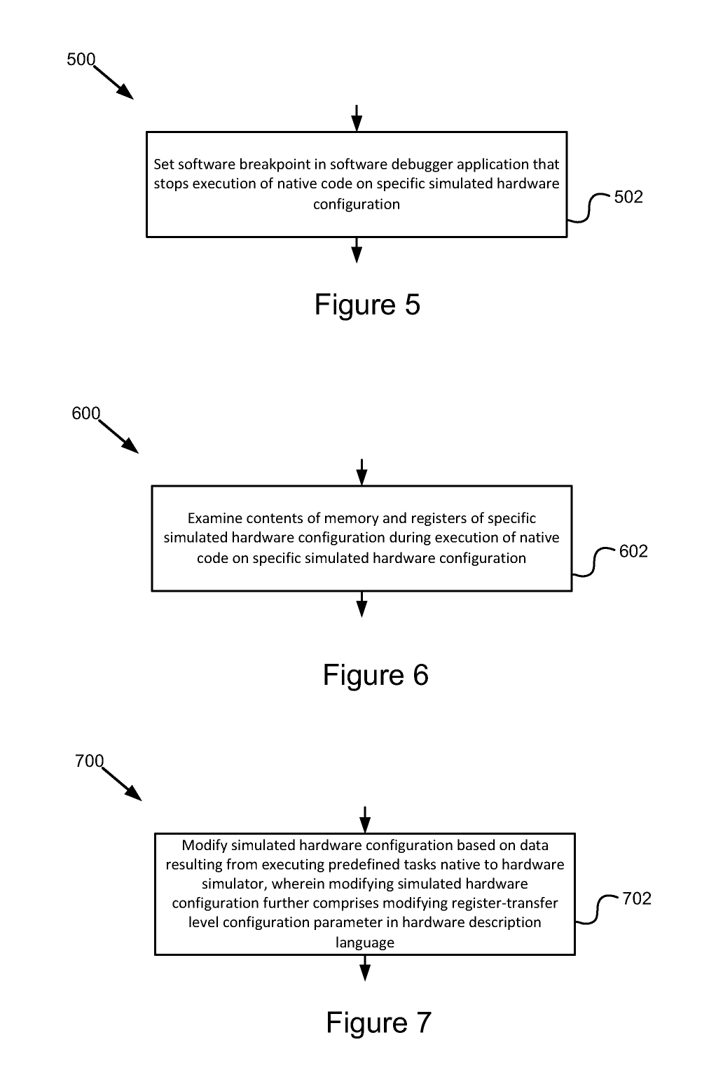

FIGS. 5 and 6 show example methods 500 and 600 for utilizing a software debugger application, according to some embodiments, to debug non-native code intended for a specific simulated hardware configuration. Block 502 of FIG. 5 comprises setting a software breakpoint in the software debugger application that stops execution of a native code on the specific simulated hardware configuration. Such breakpoints cause the code to stop executing when a given instruction or condition is met, and allows the developer to analyze and/or modify the firmware and/or the specific simulated hardware configuration without the need to wait for complete firmware code execution and subsequent recompilation.

Moreover, block 602 of FIG. 6 shows examining contents of memory and registers of the specific simulated hardware configuration during execution of the native code on the specific simulated hardware configuration. In some embodiments, the contents of memory and registers of the specific simulated hardware configuration form part of the data resulting from the execution of a task native to the specific simulated hardware configuration as discussed elsewhere herein.

FIG. 7 illustrates an example method 700 for modifying a specific simulated hardware configuration, according to some embodiments. In some embodiments, a user of computing device 200 can effectuate changes on specific simulated hardware configuration by modifying the specific simulated hardware configuration based on the data resulting from executing the predefined tasks native to the specific simulated hardware simulation. For instance, the user may modify the specific simulated hardware configuration by modifying a register-transfer level configuration parameter in a hardware description language, the hardware description language being an instantiation comprising the register-transfer level configuration parameters describing the specific simulated hardware configuration. In some cases, the hardware description language can also instantiate predefined tasks native to the specific simulated hardware configuration.

As will be understood by those skilled in the art, the invention may be embodied in other specific forms without departing from the spirit or essential characteristics thereof. Likewise, the particular naming and division of the portions, modules, servers, managers, components, functions, procedures, actions, layers, features, attributes, methodologies, data structures and other aspects are not mandatory or significant, and the mechanisms that implement the invention or its features may have different names, divisions and/or formats. The foregoing description, for the purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated.

What is claimed is:

1. A computer system comprising:
a processor;
system memory;
a receiving module residing in the system memory, the receiving module being programmed to receive a command from a software debugger application, the received command being non-native to a specific hardware configuration being simulated on a hardware simulator;
a parsing module residing in the system memory, the parsing module being programmed to parse the received non-native command;
a mapping module residing in the system memory, the mapping module being programmed to map the received non-native command to a command native to the specific simulated hardware configuration;
a transmitting module residing in the system memory, the transmitting module being programmed to:
provide the mapped native command to the hardware simulator for execution on the specific simulated hardware configuration, the receiving module being further programmed to receive data resulting from the execution of the mapped native command by the hardware simulator on the specific simulated hardware configuration; and
transmit to the software debugger application, the received data.

2. The system of claim 1 wherein a co-verification manager instantiates the receiving module, the parsing module, the mapping module, and the transmitting module, the co-verification manager comprising:
a script providing network communication server functionality establishing a protocol session between the hardware simulator and the software debugger application; and
a set of interface functions that map non-native commands received from the software debugger application to native commands executable by the hardware simulator on the specific simulated hardware configuration.

3. The system of claim 1 wherein:
the receiving module repeatedly receives non-native commands from the software debugger application;
the parsing module repeatedly parses received non-native commands;
the mapping module repeatedly maps received non-native commands to commands native to the specific simulated hardware configuration;
the transmitting module repeatedly provides mapped native commands to the hardware simulator for execution on the specific simulated hardware configuration;
the receiving module repeatedly receives data resulting from the execution of mapped native commands by the hardware simulator on the specific simulated hardware configuration; and
the transmitting module repeatedly transmits received data resulting from the execution of mapped native commands to the software debugger application.

4. The system of claim 3 wherein:
mapped native commands further comprise commands that utilize names of internal signals and chip timing native to the specific simulated hardware configuration.

5. The system of claim 3 wherein:
mapped native commands further comprise commands that read from and commands that write to registers of the specific simulated hardware configuration.

6. The system of claim 3 wherein:
mapped native commands further comprise commands that read from and commands that write to memory of the specific simulated hardware configuration.

7. The system of claim 2 wherein:
the co-verification manager enables utilization of the software debugger application to debug code native to the specific simulated hardware configuration.

8. The system of claim 7 wherein utilization of the software debugger application to debug code on the specific simulated hardware configuration further comprises:
setting a software breakpoint in the software debugger application that stops execution of the native code on the specific simulated hardware configuration.

9. The system of claim 1 wherein the specific simulated hardware configuration further comprises:
a hardware description language instantiation comprising:
register-transfer level configuration parameters describing the specific simulated hardware configuration; and
predefined tasks native to the specific simulated hardware configuration.

10. The system of claim 9 wherein:
the predefined tasks native to the specific simulated hardware configuration comprise functional chip initialization, direct memory interface and functional bus interface tasks.

11. The system of claim 9 further comprising:
modifying the simulated hardware configuration based on data resulting from executing the predefined tasks native to the specific simulated hardware configuration, wherein modifying the simulated hardware configuration further comprises modifying a register-transfer level configuration parameter in the hardware description language.

12. The system of claim 1, wherein:
data resulting from the execution of the task by the hardware simulator comprises functional and timing verification data concerning the specific simulated hardware configuration.

13. The system of claim 1, wherein:
the software debugger application and the hardware simulator execute on separate computers.

14. A computer implemented method comprising:
receiving, by a co-verification manager executing on a computer, a command from a software debugger application, the received command being non-native to a specific hardware configuration being simulated on a hardware simulator;
parsing, by the co-verification manager, the received non-native command;
mapping, by the co-verification manager, the received non-native command to a command native to the specific simulated hardware configuration;
providing, by the co-verification manager, the mapped native command to the hardware simulator for execution on the specific simulated hardware configuration;
receiving, by the co-verification manager, data resulting from the execution of the mapped native command by the hardware simulator on the specific simulated hardware configuration; and
transmitting, from the co-verification manager to the software debugger application, the received data.

15. The method of claim 15, wherein the co-verification manager is instantiated as:
a script providing network communication server functionality establishing a protocol session between the hardware simulator and the software debugger application; and
a set of interface functions that map non-native commands received from the software debugger application to native commands executable by the hardware simulator on the specific simulated hardware configuration.

16. The method of claim 15 wherein the co-verification manager repeatedly:
receives non-native commands from the software debugger application;
parses received non-native commands;
maps received non-native commands to commands native to the specific simulated hardware configuration;
provides mapped native commands to the hardware simulator for execution on the specific simulated hardware configuration;
receives data resulting from the execution of mapped native commands by the hardware simulator on the specific simulated hardware configuration; and
transmits received data resulting from the execution of mapped native commands to the software debugger application.

17. The method of claim 17 wherein mapped native commands further comprise:
commands that utilize names of internal signals and chip timing native to the specific simulated hardware configuration;
commands that read from and commands that write to registers of the specific simulated hardware configuration; and
commands that read from and commands that write to memory of the specific simulated hardware configuration.

18. The method of claim 15 wherein the specific simulated hardware configuration further comprises:
a hardware description language instantiation comprising:
register-transfer level configuration parameters describing the specific simulated hardware configuration; and
predefined tasks native to the specific simulated hardware configuration, and wherein the predefined tasks native to the specific simulated hardware configuration comprise functional chip initialization, direct memory interface and functional bus interface tasks.

19. The method of claim 15, further comprising:
modifying the simulated hardware configuration based on data resulting from executing the predefined tasks native to the specific simulated hardware configuration, wherein modifying the simulated hardware configuration further comprises modifying a register-transfer level configuration parameter in the hardware description language.

20. A system comprising:
means for receiving, by a co-verification manager executing on a computer, a command from a software debugger application, the received command being non-native to a specific simulated hardware configuration being simulated on a hardware simulator;
means for parsing, by the co-verification manager, the received non-native command;
means for mapping, by the co-verification manager, the received non-native command to a command native to the specific simulated hardware configuration;
means for providing, by the co-verification manager, the mapped native command to the hardware simulator for execution on the specific simulated hardware configuration;
means for receiving, by the co-verification manager, data resulting from the execution of the mapped native command by the hardware simulator on the specific simulated hardware configuration; and
means for transmitting, from the co-verification manager to the software debugger application, the received data.
